(19) United States
(12) Patent Application Publication
(10) Pub. No.: US 2023/0112663 A1
(43) Pub. Date: Apr. 13, 2023

(54) Special commercial nail application kiosk, commercial bench machine and related processes

(71) Applicant: Erica Brown, Indianapolis, IN (US)

(72) Inventor: Erica Brown, Indianapolis, IN (US)

(21) Appl. No.: 17/958,339

(22) Filed: Oct. 1, 2022

Related U.S. Application Data
(60) Provisional application No. 63/251,621, filed on Oct. 2, 2021.

(51) Int. Cl. A45D 29/18; A45D 29/14

(52) U.S. Cl. CPC A45D 29/18; A45D 29/14

(57) ABSTRACT

A commercial nail application bench machine, kiosk, and process comprised of combinations of components and several steps. The commercial nail application machine includes a bench machine for multiple technicians with a bench structure for the technicians, a set of hand rests, a pair of UV/LED lights and dry/finish cure chamber, a pick and place for artificial nail placement with camera assist, an articulated motorized arm for nail preparation, removal and preparation, a colored polish and clearcoat application mechanism with cartridges for polish, clearcoat and adhesives, and a way to secure the pick and place and other components to the bench structure. This commercial nail application machine can be used for rapid and repeatable quality artificial nail placement by nail technicians. A process to use the commercial machine is included.

### CROSS-REFERENCE TO RELATED APPLICATIONS

This application claims the benefit of United States Provisional Pat. Application with Serial Number 63251621 filed Oct. 2, 2021, by Erica Brown. The application is entitled “Special commercial nail application kiosk, commercial bench machine and related processes”.

### FIELD OF INVENTION

This invention relates to a Special commercial nail application machine and process. Particularly this relates to human nail decorations, and more specifically the invention pertains to structure and methods for placement of preformed artificial nails and tips for adherence to human nails. It further relates to human fingernail decorations, and more particularly to artificial nails that are intended to be adhered to a human’s natural fingernail and to a nailcare device.

### FEDERALLY SPONSORED RESEARCH

None.

### SEQUENCE LISTING OR PROGRAM

None.

### BACKGROUND-FIELD OF INVENTION AND PRIOR ART

This section is not Applicable to Provisional Applications. However, as far as known, there are no special commercial nail application bench or kiosk machines and related processes or the like. It is believed that these products and processes are unique in their design and technologies.

### BACKGROUND

For various aesthetic reasons, many individuals wish to possess elongated fingernails or fingernails having a more finished or polished appearance. However, some are unable or unwilling to grow their own natural fingernails out to the desired length. Alternately, they may not have the time, skill, or financial wherewithal to maintain or obtain a more finished appearance that may result from well-manicured and/or polished nails. As a result, entire industries have developed around the artificial supplementation and enhancement of natural nails. Such enhancements may range from manicuring and polishing of natural fingernails to individually building artificial nails on the natural nail and nail form from an acrylic powder and liquid which chemically bond to the nail surface as the artificial nail is built. Between these two extremes, are preformed, artificial nails that are glued or otherwise bonded to a person’s own naturally occurring fingernails. Such nails are readily available to a wide range of users through drug and department stores. Such preformed artificial nails may be clear or opaque, and/or pre-polished and/or decorated to provide the desired appearance.

Artificial nails are commonly made from molded thermoplastic and are available in a wide range of lengths and styles. One broad category of an artificial nail style is the full nail form. As its name implies, the full nail form simulates the entire human fingernail and includes a proximate edge intended to overlay substantially the entire nail bed and a distal free edge which is intended to extend beyond the fingertip of the wearer. The proximate edge is shaped to be disposed substantially adjacent or abut against the cuticle of the finger. The distal free edge may have any of various lengths and shapes, such as oval, square, or flared, depending upon the desired look. Additionally, to further simulate a natural fingernail, the artificial nail is typically formed with a curvature between a first side edge and a second side and a curvature between the proximate and distal edges. Preferably, the artificial nail is sufficiently durable and rigid to withstand the hazards inherent in its use.

Manufacturers typically provide users with a range of nail sizes, e.g., identified by size numbers 0-9, to accommodate most nail sizes. Generally, artificial nails are packaged together in sets including a range of different sizes so that the purchaser receives differently artificial nails for their different fingers. In addition to the set of different sized artificial nails, the package may also include liquid adhesive and/or peel-off adhesive pads for bonding the artificial nails to the purchaser’s natural fingernails.

It is well known, however, that the contour of natural fingernails varies greatly between individuals and even between different fingers on the same individual. It has been difficult, if not impossible, to produce artificial nails having degrees of curvature between the first and second side edges and proximate and distal edges that accommodate all-natural fingernails. While manufacturers may produce many artificial nails with a variety of curves, this solution is undesirable and impractical because of the associated increase in manufacturing costs. As a result, manufactures typically produce a set of preformed artificial nails have varying widths and including set degrees of curvature.

### Problem Solved

The improvement and problem solved as to Special commercial nail application kiosk, commercial bench machine and related processes include: A. Faster application than bench only; B. Repetitive quality of placement and adhesive; C. Less time means more profit or less price; D. Repetitive color application equals consistent quality; and E. Well organized bench for repetitive application.

### Prior Art

It is believed that this product is unique in its design and technologies. A novelty search revealed:
(A) a U.S. Pat. Application 20160000204 by Yamasaki called a DRAWING APPARATUS AND CONTROL METHOD OF THE DRAWING APPARATUS. It is a drawing apparatus comprises a controlling unit which adjusts a size of a design image formed by an image data, the image data includes position information of a key point which is predetermined set, without changing an aspect ratio of the design image and the relative position of the key point, generates an adjusted design image, and fits the adjusted design image to a drawing region of a nail; and a drawing unit for drawing the adjusted design image on the drawing region. The controlling unit sets an adjustment point in the drawing region at the same relative positions in the longitudinal and lateral directions as the key point set on the design image, and, in the fitting, sets the adjusted design image to the drawing region at a position which the key point of the adjusted design image meets the adjustment point. ;
(B) U.S. Pat. 8960200 — Coppola et al. is called Artificial nails including application tabs. It reveals a kit including a package containing a plurality of preformed artificial nails having an application tab that removably clings to a surface of the nail, the application tab assembly including a body protruding from the nail, an attachment portion, and, optionally, an adhesive disposed between the body and the artificial nail. The clinging portion of the attachment portion, and the adhesive, if utilized, leaves substantially no residue on the artificial nail when the application tab assembly is removed from the surface of the artificial nail;
(C) a U.S. Pat. 8746820 was issued to Murata and was called a Nail print apparatus and print controlling method. This disclosed a nail print apparatus including: a photographing section which photographs a plurality of fingers and a nail section of each finger to obtain a finger image; a finger type detecting section which detects a type of each finger from the finger image; a first storage controlling section which stores the type of finger detected by the finger type detecting section corresponded with the nail image; a design specifying section which receives specification of a design image to be printed; a second storage controlling section which stores the design image specified on the design specifying section; a combined nail image generating section which combines the design image with the nail image for each type of finger to generate a combined nail image; and a print controlling section which controls printing of the combined nail image on the nail chip sheet.;
(D) a U.S. Pat. 8851085 by Fracassi, et al. was called Paired artificial nails. Here a preformed artificial nail assembly comprising a pair of artificial nails sized to correspond to at least a portion of said natural nail, and an application tab assembly extending between the pair of artificial nails. The application tab assembly includes a body portion and a neck portion adjacent each said artificial nail, said neck portion being disposed between the body portion and the lower surface of the free edge of the artificial nail. The application tab assembly may include an area of weakness that allows the assembly to be separated into two separate tabs, one adjacent each of the artificial nails of the pair. The user may utilize the application tab assembly as a single unit to place the nails, or separate the assembly into two separate tabs to allow the user to place the nails utilizing separate tabs;
(E) a U.S. Pat. 6799579 issued to Joseph was called a Fingernail and toenail shaping apparatus. This portrays a belt cartridge that is releasably attachable to a manicuring machine having a drive roller that is insertable into the belt cartridge for engagement of the drive roller with flexible belt contained in the cartridge includes a retainer for holding the flexible belt near a predefined circuitous path when the cartridge is not installed on the manicuring machine. The retainer eliminates any need for manipulating the flexible belt before or during attachment of the cartridge to the manicuring machine. A protuberance on the back wall of the cartridge is provided for engagement with a recess in a mounting face of the manicuring machine to inhibit movement of the cartridge with respect to the manicuring machine. This engagement between the protuberance and the recess locks the cartridge onto the manicuring machine during normal use without the need for a separately actuated locking pin.
(F) Finally, a Pat. 7475687 earned by Merten was called a Nailcare device with a discoid grinding body driven by an electric. The invention relates to a nailcare device, comprising a housing (1) and a discoid grinding body (4), driven by an electric motor, sitting on a driveshaft (10), connected to an electric motor (6). The essentially discoid grinding body (4) is arranged in the upper part of the device housing (1), beneath a cover or plate (3), parallel to the upper side (4a) of the grinding body (4), fixed to the housing (1) of the device in an easily detachable manner and with at least two slots (3a) for the fingernail of the user as close as possible to the grinding body (4) at differing radial separations from the driveshaft (10). The cover or plate (3) can be funnel- or cone-shaped with relation to the grinding body (4), such that the axial separation between the upper side (4a) of the discoid grinding body (4) and the slots (3a), arranged at various radial separations from the driveshaft (10), increases or decreases with increasing separation from the driveshaft (10). The above presents the advantage that, because of the varying separation of the slots (3a) from the upper side (4a) of the grinding body (4) and the various forms of the slots (3a), not only crowned fingernails but also those of the right and left hands can be treated one after the other without a change of template. The device can also be placed on a level surface for carrying out the nail treatment and doesn’t need to be guided by the other hand, permitting a single-handed treatment of the nails and thus significantly facilitates the use for nailcare by handicapped people with only one hand and people requiring assistance.

As can be observed, none of the prior art has anticipated or caused one skilled in the art of artificial nail placement and finishing for commercial products and processes to anticipate or see as obvious this invention by Erica Brown even to a person skilled in the ordinary art of the industry. The kiosk and multiple technician bench with placement and coloring components provide an answer to the artificial nail industry to make the process high quality, fast and repeatable.

### SUMMARY OF THE INVENTION

This invention is A Special commercial nail application bench machine, kiosk, and process comprised of combinations of many components and several steps. The preferred embodiments of the Special commercial nail application machine and process are comprised as follows: (1) A Special commercial nail application bench machine for multiple technicians comprised of: (a) a multiple technician commercial bench structure with sides, ends, and a top; (b) a set of hand rests; (c) a pair of UV/LED lights and dry/finish cure chamber; (d) pick and place for artificial nail placement with camera assist; (e) an articulated motorized arm for nail preparation, removal and preparation; (f) a colored polish and clearcoat application mechanism with cartridges with polish, clearcoat and adhesives; and (g) a means to secure the pick and place and other components to the bench structure wherein the Special commercial nail application machine can be used for rapid and repeatable quality artificial nail placement by nail technicians. (2) A Special commercial nail application kiosk machine comprised of: (a) a kiosk structure with a base and an input/ selection screen having control accessories; (b) a set of hand rests; (c) a pair of UV/LED lights and dry/finish cure chamber; (d) pick and place for artificial nail placement with camera assist; (e) an articulated motorized arm for nail preparation, removal and preparation; (f) a colored polish and clearcoat application mechanism with cartridges with polish, clearcoat and adhesives; and (g) a means to secure the pick and place and other components to the kiosk structure wherein the Special commercial nail application machine can be used for rapid and repeatable quality artificial nail placement using a computer controlled kiosk. AND (3) A Special commercial nail application process by a nail technician on a bench comprised of the following steps: Step 1: Select Tip Length, Style, color, adds — Client and stylist discussion; Step 2: Color cartridge — Select or prep color cartridge, load applicator; Step 3: Remove old — Peel, release liquid acetone; Step 4: Clean, buff, & Primer — Manual or light buff head; Step 5: Size nail — Measure natural surface and match to tip; Step 6: Place Adhesive — Manual Application or spray; Step 7: Place Tip — Manual or pick and place fixture; Step 8: Shape Tip —Clip grind, hand or machine file; Step 9: Place color — Brush or dip, gel or acrylic applicator; Step 10: Cure — Lamp/ dryer; Step 11: File to smooth — Manual or light buff head; Step 12: Second/ third coat — Brush or dip, gel, or acrylic applicator; Step 13: Cure — Lamp/ dryer; Step 14; Polish —Manual or light buff head; Step 15: Clear coat - Brush, gel, or acrylic applicator; Step 16: Cure/dry — Lamp/ dryer; Step 17: Buff — Manual buff; and Step 18: Final Inspection —Inspect quality by stylist.

The newly invented Special commercial nail application machine for various applications may be manufactured at low volumes by very simple means and in high volume production by more complex and controlled systems.

### Objects and Advantages

There are several objects and advantages of the Special commercial nail application bench or kiosk machines and related processes. There are currently no known devices that are effective at providing the objects of this invention. The advantages and benefits include:

| Item | Advantages |
|---|---|
| 1 | Faster application than bench only |
| 2 | Repetitive quality of placement and adhesive |
| 3 | Less time means more profit or less price |
| 4 | Repetitive color application equals consistent quality |
| 5 | Well organized bench for repetitive application |
| 6 | Multiple benches with shared tools |
| 7 | Dishwasher safe materials, |
| 8 | Quasi-sterilizable surfaces and tools |

Finally, other advantages and additional features of the present Special commercial nail application bench or kiosk machines and related processes will be more apparent from the accompanying drawings and from the full description of the device. For one skilled in the art of commercial artificial nail application and coloring and the devices and process associated with this, it is readily understood that the features shown in the examples with this product are readily adapted to other types of artificial nail placement devices and processes.

### DESCRIPTION OF THE DRAWINGS - FIGURES

The accompanying drawings, which are incorporated in and constitute a part of this specification, illustrate an embodiment of the Special commercial nail application bench or kiosk machines and related processes that are preferred. The drawings together with the summary description given above and a detailed description given below explain the principles of the devices and processes. It is understood, however, that the Special commercial nail application bench or kiosk machines and related processes are not limited to only the precise arrangements and instrumentalities shown.

FIGS. 1 A through 1 C are sketches of the general nail machine and process for commercial applications device.

FIGS. 2 A through 2 C are sketches of the general commercial nail bench for multiple nail technicians with components and features noted.

FIGS. 3 A through 3 C are sketches of a single technician bench for commercial applications with the components and features shown from generally a top view.

FIG. 4 is a process flow for the commercial nail technician.

FIG. 5 are drawings of the various steps for the commercial nail application.

FIGS. 6 A and 6 B are sketches of a kiosk nail application unit.

FIGS. 7 A through 7 D are sketches of the kiosk machine with various components and features shown.

FIG. 8 is a sketch of the color, clear, primer and purge for the kiosk machine.

FIG. 9 A through 9 C are sketches of the nail cleaning, placing and buffing equipment for the kiosk machine.

FIG. 10 is a sketch of process steps for a kiosk machine.

FIGS. 11 A through 11 F are sketches of prior art for nail application machines.

### DESCRIPTION OF THE DRAWINGS - REFERENCE NUMERALS

The following list refers to the drawings:

TABLE B

Reference numbers

| Ref # | Description |
|---|---|
| 30 | Commercial nail machine and bench 30 |
| 33 | Single technician bench and machine 33 |
| 35 | Multiple technician commercial bench and machine 35 |
| 36 | Nail bench structure 36 sides, ends, and top |
| 37 | Means to secure 37 the pick and place 43 and other components to the bench structure 36 |
| 38 | Storage cabinet 38 |
| 39 | Drawers 39 for storage |
| 40 | Battery or electric operated Dremel/rotary tool 40 |
| 41 | Cleanup tools 41 such as emery drum, cylinders, small cylinders, bullet, needle, and rotary buffing tools |
| 42 | Augmenting arm 42 of pick and place 43 |
| 43 | Pick and place 43 and base |
| 43A | Camera 43A |
| 44 | Color cylinders 44 |
| 45 | Nail color acrylic or gel pressure application 45 such as Light Pink, Classic Red, Nude, Hot Pink, Glitter, Gray, Metallic, White, Lavender, and Navy |
| 47 | Foot pedal 47 for pick place 43 and Dremel 40 |
| 50 | Thickness check mechanism 50 |
| 60 | Color and prep mechanism 60 |
| 61 | Horizontal front back rails 61 |
| 62 | Horizontal left-right rails 62 |
| 63 | Cameras 63 (color, clear coat, purge, etc.) |
| 64 | Application nozzles 64 |
| 68 | UV/LED lights and dry/ finish cure chamber 68 |
| 69 | Hand rest 69 to separate nails 110 |
| 69A | Structure / plat form 69A for hand rest 69 |
| 70 | Kiosk nail placement machine 70 |
| 71 | Control/ computer module 71 with power 72 |
| 72 | Power 72 |
| 73 | Kiosk structure 73 |
| 74 | Kiosk base 74 |
| 75 | Input/ selection screen 75 |
| 77 | Control accessories 77 - input knobs, buttons, keyboard |
| 79 | Means 79 to secure pick and place 80, color prep 60, and other accessories to kiosk structure 73 |
| 80 | Pick and place mechanism 80 |
| 88 | Purge line opening 88 purge reservoir 89 |
| 89 | Purge reservoir 89 |
| 90 | Process 90 for commercial nail placement for bench |
| 95 | Process 95 for kiosk commercial nail placement |
| 99 | Visual process 99 for commercial nail placement from bench |
| X | Nail technician X |
| Y | Client Y |
| 100 | Hand 100 |
| 110 | Artificial nails 110 various types such as, for example, Coffin, Stiletto, Square, Round, and Almond among others |
| 120 | Auxiliary nail art system 120 |
| 121 | Prime and purge motor 121 |
| 122 | Clean coat motor 122 |
| 123 | Color motor 123 |
| 124 | Front to back motor 124 |
| 125 | Control, power, and instrumentation wiring 125 from various motors to control module 71,72 |
| 126 | Articulation motor 126 |
| 200 | Prior art 200 U.S. Pat. Application 20160000204 - Yamasaki |
| 201 | Prior Art 201 U.S. Pat. 8960200 - Coppola et al. |
| 202 | Prior Art 202 U.S. Pat. 8746820 - Murata |
| 203 | Prior Art 203 U.S. Pat. 8851085 - Fracassi, et al. |
| 20 4 | Prior Art 204 U.S. Pat. 6799579 - Joseph |
| 205 | Prior Art 205 U.S. Pat. 7475687 - Marten |

### DETAILED DESCRIPTION OF PERFERRED EMBODIMENT

This invention relates to a Special commercial nail application machine and process. Particularly this relates to human nail decorations, and more specifically the invention pertains to structure and methods for placement of preformed artificial nails and tips for adherence to human nails. It further relates to human fingernail decorations, and more particularly to artificial nails that are intended to be adhered to a human’s natural fingernail and to a nailcare device.

The advantages for the Special commercial nail application bench or kiosk machines and related processes are listed above in the introduction. Succinctly the benefits are:
A. Faster application than bench only
B. Repetitive quality of placement and adhesive
C. Less time means more profit or less price
D. Repetitive color application equals consistent quality
E. Well organized bench for repetitive application
F. Multiple benches with shared tools
G. Dishwasher safe materials, and
H. Quasi-sterilizable surfaces and tools

The preferred embodiments of the Special commercial nail application machine and process are comprised as follows: (1) A Special commercial nail application bench machine for multiple technicians comprised of: (a) a multiple technician commercial bench structure with sides, ends, and a top; (b) a set of hand rests; (c) a pair of UV/LED lights and dry/finish cure chamber; (d) pick and place for artificial nail placement with camera assist; (e) an articulated motorized arm for nail preparation, removal and preparation; (f) a colored polish and clearcoat application mechanism with cartridges with polish, clearcoat and adhesives; and (g) a means to secure the pick and place and other components to the bench structure wherein the Special commercial nail application machine can be used for rapid and repeatable quality artificial nail placement by nail technicians. (2) A Special commercial nail application kiosk machine comprised of: (a) a kiosk structure with a base and an input/ selection screen having control accessories; (b) a set of hand rests; (c) a pair of UV/LED lights and dry/finish cure chamber; (d) pick and place for artificial nail placement with camera assist; (e) an articulated motorized arm for nail preparation, removal and preparation; (f) a colored polish and clearcoat application mechanism with cartridges with polish, clearcoat and adhesives; and (g) a means to secure the pick and place and other components to the kiosk structure wherein the Special commercial nail application machine can be used for rapid and repeatable quality artificial nail placement using a computer controlled kiosk. AND (3) A Special commercial nail application process by a nail technician on a bench comprised of the following steps: Step 1: Select Tip Length, Style, color, adds — Client and stylist discussion; Step 2: Color cartridge - Select or prep color cartridge, load applicator; Step 3: Remove old — Peel, release liquid acetone; Step 4: Clean, buff, & Primer — Manual or light buff head; Step 5: Size nail — Measure natural surface and match to tip; Step 6: Place Adhesive — Manual Application or spray; Step 7: Place Tip — Manual or pick and place fixture; Step 8: Shape Tip —Clip grind, hand or machine file; Step 9: Place color - Brush or dip, gel or acrylic applicator; Step 10: Cure — Lamp/ dryer; Step 11: File to smooth — Manual or light buff head; Step 12: Second/ third coat — Brush or dip, gel, or acrylic applicator; Step 13: Cure — Lamp/ dryer; Step 14; Polish —Manual or light buff head; Step 15: Clear coat — Brush, gel, or acrylic applicator; Step 16: Cure/dry — Lamp/ dryer; Step 17: Buff — Manual buff; and Step 18: Final Inspection —Inspect quality by stylist.

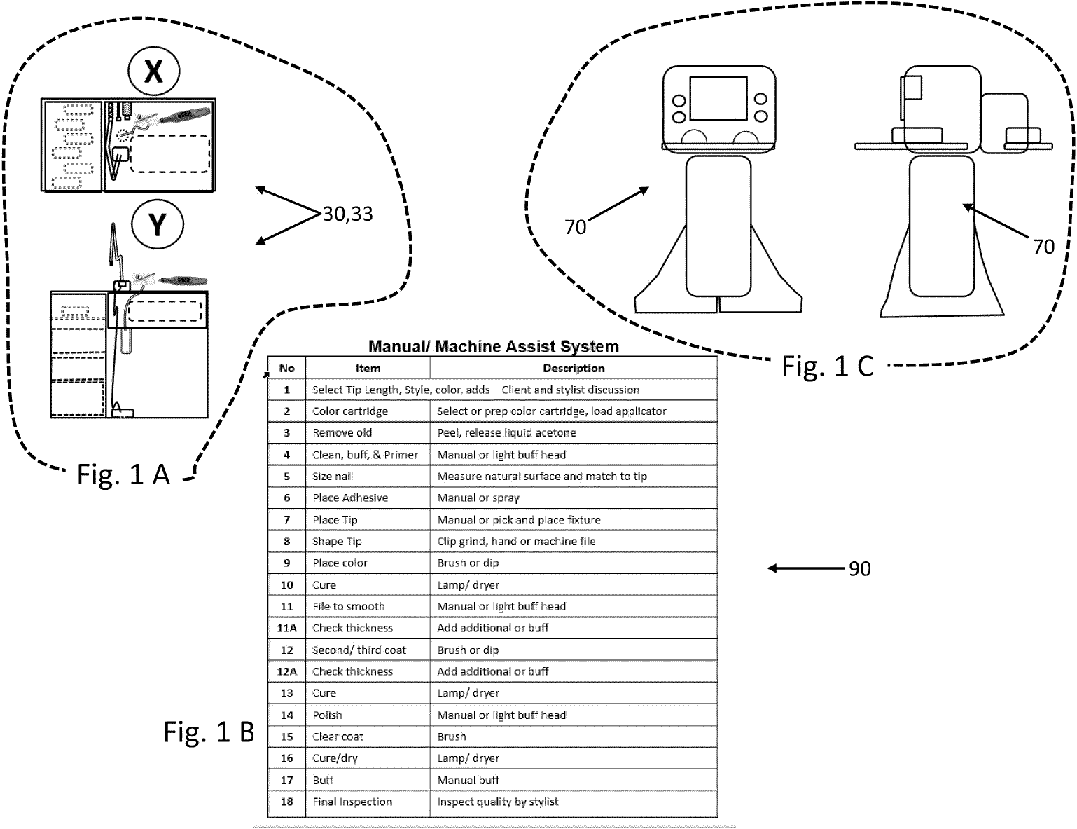

There is shown in FIGS. 1-11 a complete description and operative embodiment of the Special commercial nail application bench 35 or kiosk machines 70 and related processes 90,95. In the drawings and illustrations, one notes well that the FIGS. 1-11 demonstrate the general configuration and use of this product. The various example uses are in the operation and use section, below.

FIGS. 1 A through 1 C are sketches of the general nail machine and process for commercial applications device. Portrayed here are: a commercial nail machine and bench 30; a single technician bench and machine 33; a Kiosk nail placement machine 70; and a process 90 for commercial nail placement for bench.

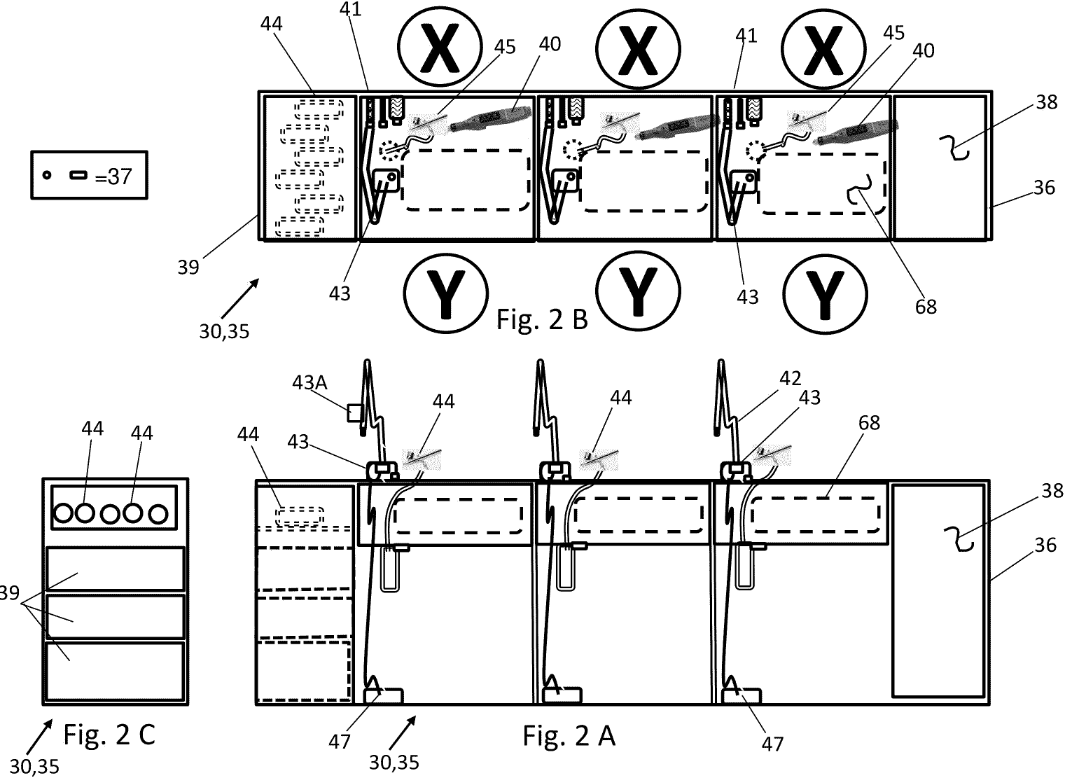

FIGS. 2 A through 2 C are sketches of the general commercial nail bench for multiple nail technicians with components and features noted. Shown here include the following: a commercial nail machine and bench 30; a multiple technician commercial bench and machine 35; a nail bench structure 36 sides, ends, and top; a means to secure 37 the pick and place 43 and other components to the bench structure 36; a storage cabinet 38; a set of drawers 39 for storage; a battery or electric operated Dremel/rotary tool 40; a set of cleanup tools 41 such as an emery drum, cylinders, small cylinders, bullet, needle and rotary buffing tools; an augmenting arm 42 of pick and place 43; a pick and place 43 and base; a camera 43A; a set of color cylinders 44 - such as Light Pink, Classic Red, Nude, Hot Pink, Glitter, Gray, Metallic, White, Lavender, and Navy; a nail color acrylic or gel pressure application 45; a foot pedal 47 for pick place 43 and Dremel 40; and a UV/LED lights and dry/ finish cure chamber 68; a nail technician X; and a client Y.

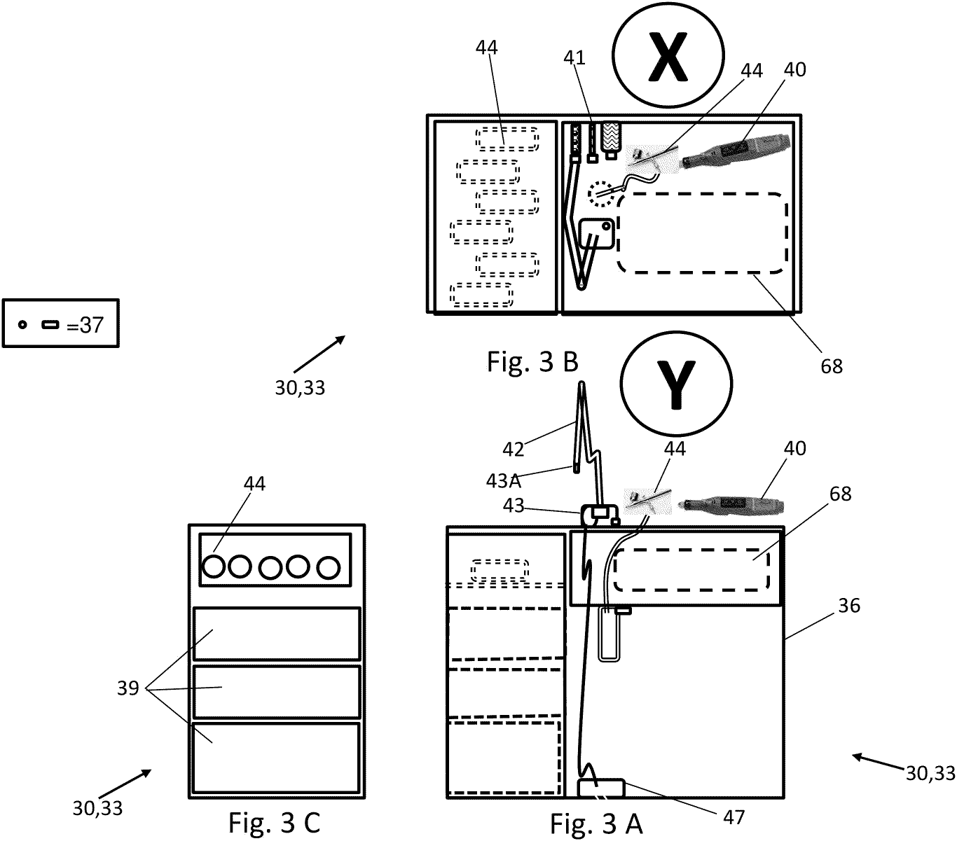

FIGS. 3 A through 3 C are sketches of a single technician bench for commercial applications with the components and features shown from generally a top view. Demonstrated here are: a commercial nail machine and bench 30; a single technician bench and machine 33; a nail bench structure 36 sides, ends, and top; a means to secure 37 the pick and place 43 and other components to the bench structure 36; a set of drawers 39 for storage; a battery or electric operated Dremel/rotary tool 40; a set of cleanup tools 41 such as an emery drum, cylinders, small cylinders, bullet, needle and rotary buffing tools; an augmenting arm 42 of pick and place 43; a pick and place 43 and base; a camera 43A; a set of color cylinders 44 — such as Light Pink, Classic Red, Nude, Hot Pink, Glitter, Gray, Metallic, White, Lavender, and Navy; a nail color acrylic or gel pressure application 45; a foot pedal 47 for pick place 43 and Dremel 40; a UV/LED lights and dry/ finish cure chamber 68; a nail technician X; and a client Y.

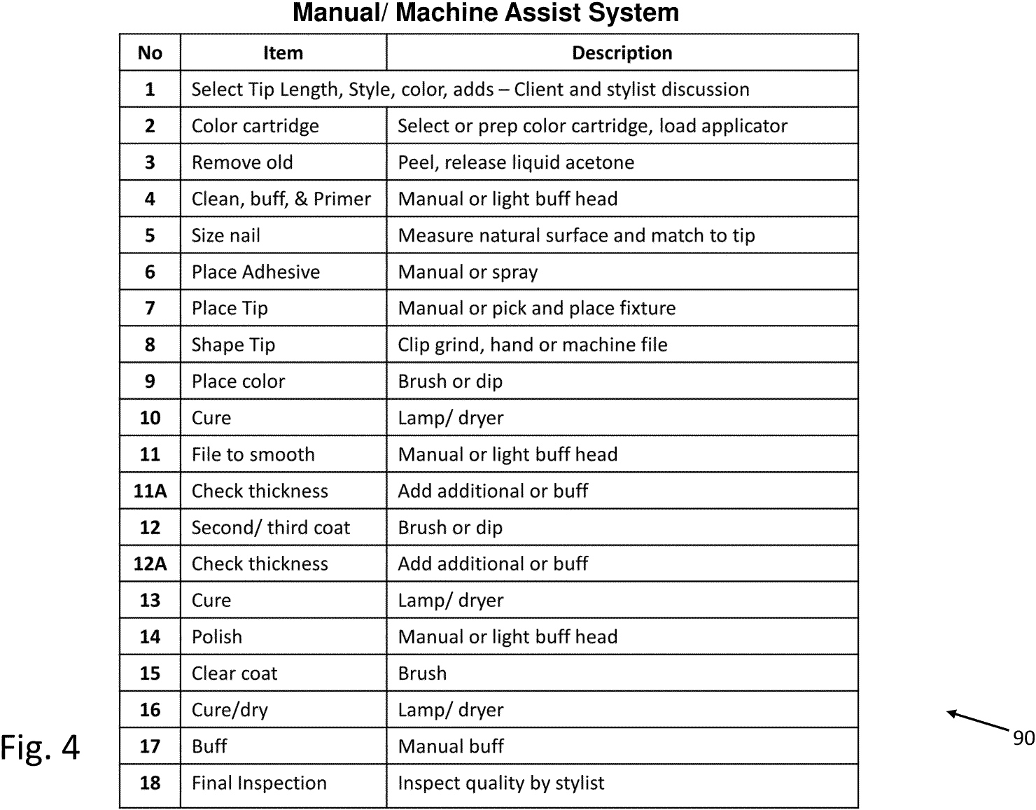

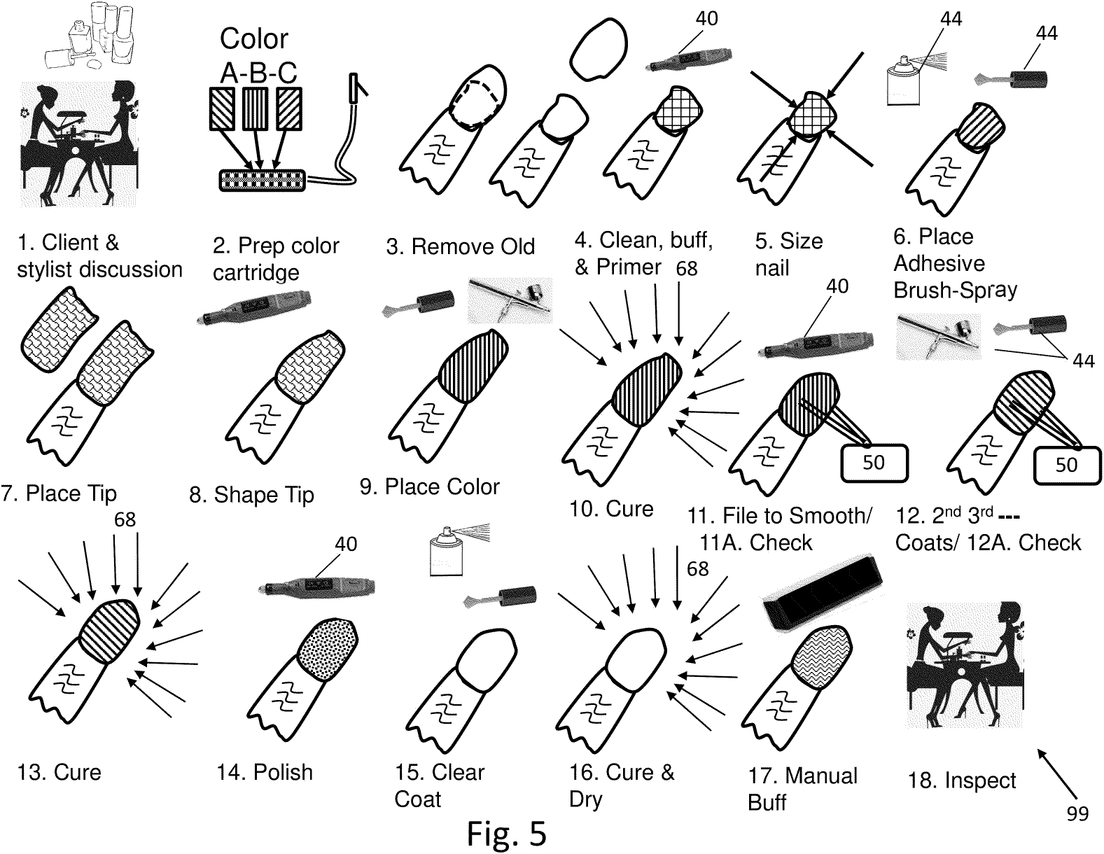

FIG. 4 A is a process flow for the commercial nail technician. FIG. 5 are drawings of the various steps for the commercial nail application. These are described in the operation section, below.

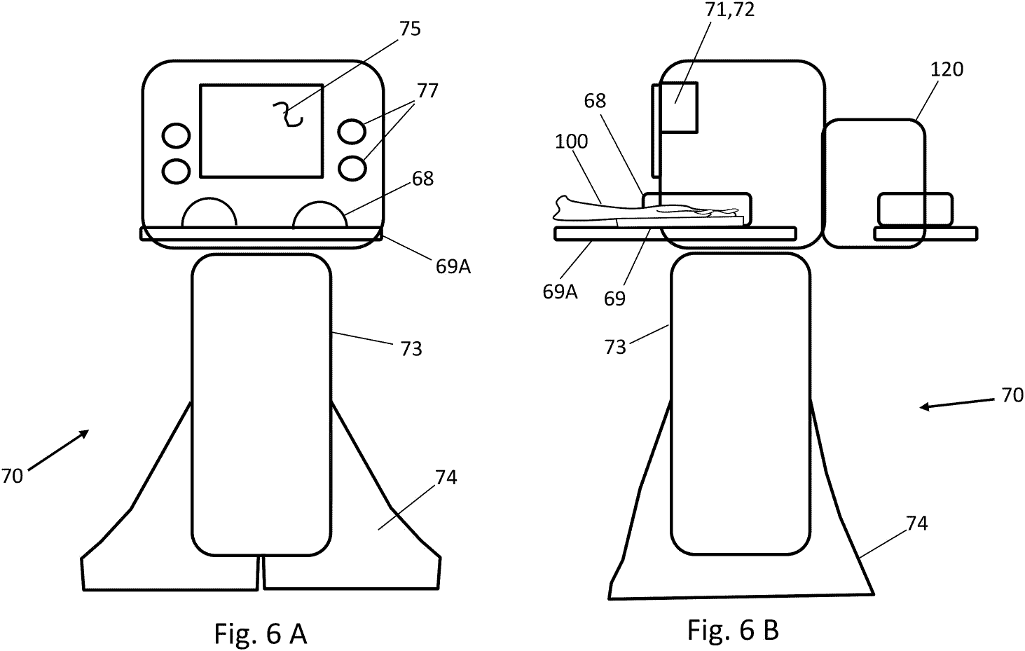

FIGS. 6 A and 6 B are sketches of a kiosk nail application unit. In these views on sees: a UV/LED lights and dry/ finish cure chamber 68; a hand rest 69 to separate nails 110; a structure / plat form 69A for hand rest 69; a Kiosk nail placement machine 70; a control/ computer module 71 with power 72; electric power 72; a Kiosk structure 73 kiosk base 74; a kiosk base 74; an input/ selection screen 75; a set of control accessories 77 — input knobs, buttons, keyboard; a hand 100; and an auxiliary nail art system 120.

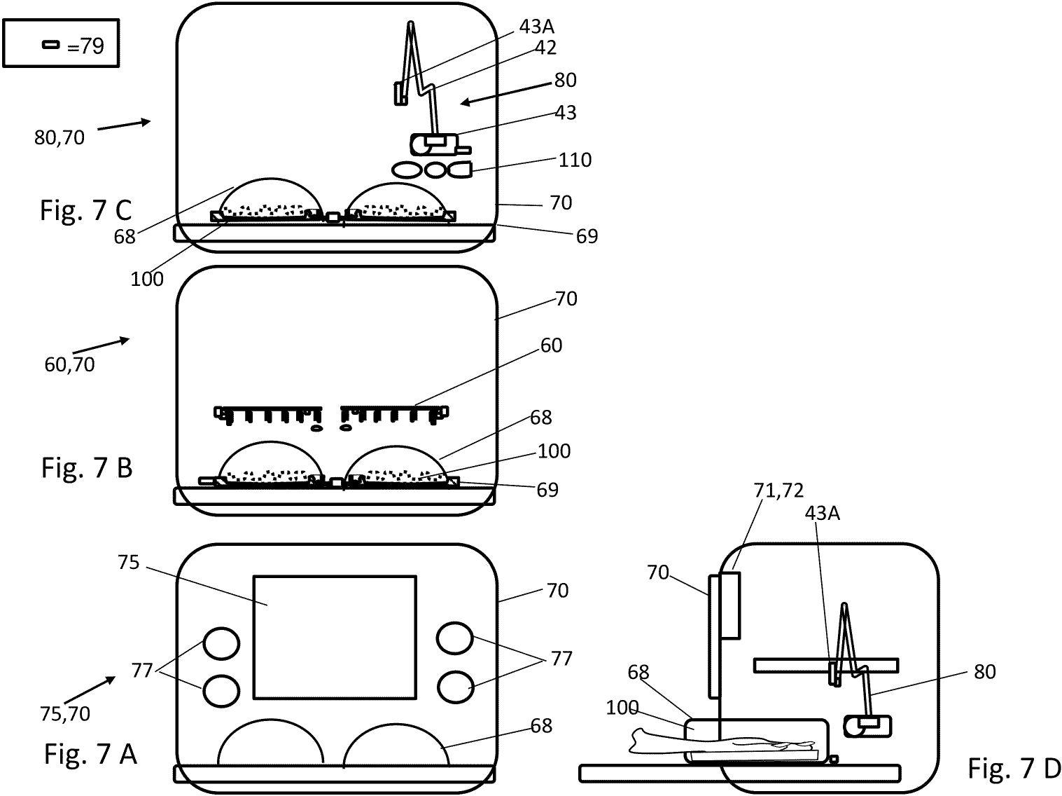

FIGS. 7 A through 7 D are sketches of the kiosk machine with various components and features shown. Demonstrated are: an augmenting arm 42 of pick and place 43; a pick and place 43 and base; a camera 43A; a color and prep mechanism 60; a UV/LED lights and dry/ finish cure chamber 68; a hand rest 69 to separate nails 110; a Kiosk nail placement machine 70; a control/ computer module 71 with power 72; electric power 72; an input/ selection screen 75; a set of control accessories 77 — input knobs, buttons, keyboard; a means 79 to secure pick and place 80, color prep 60, and other accessories to kiosk structure 73; a pick and place mechanism 80; a hand 100; and a set of artificial nails 110 various types — such as, for example, Coffin, Stiletto, Square, Round, and Almond among others.

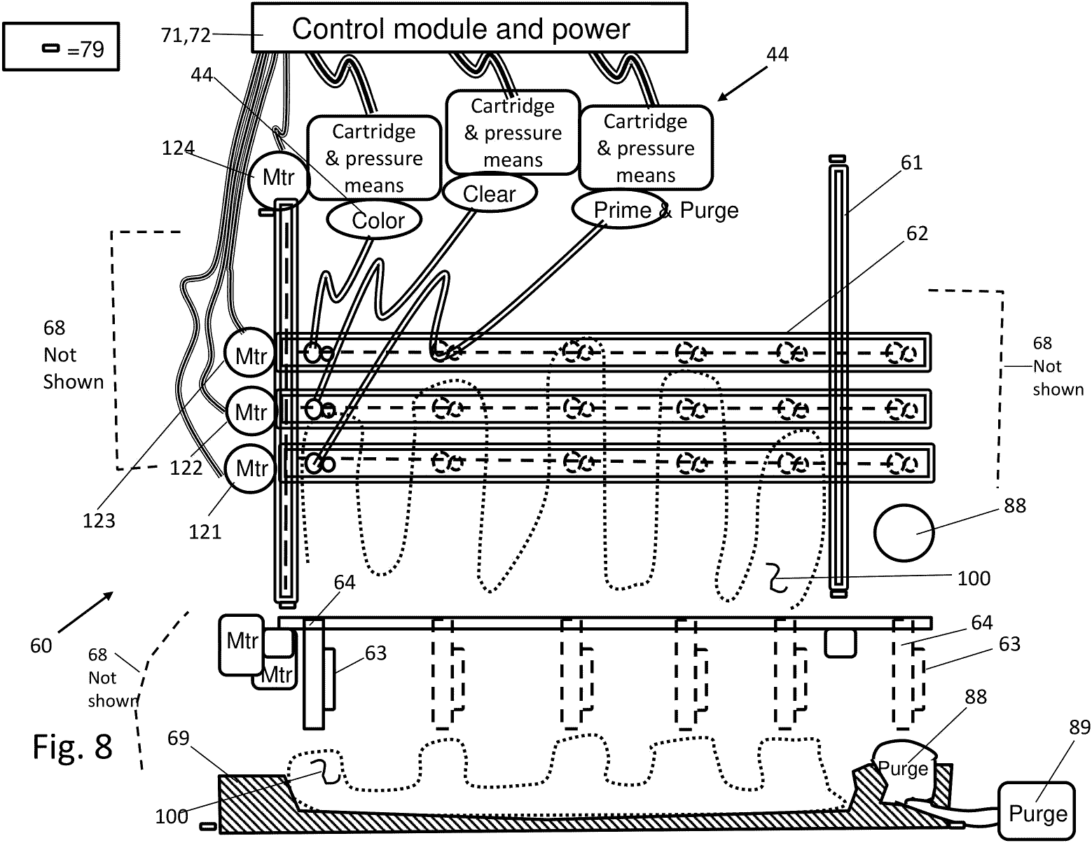

FIG. 8 is a sketch of the color, clear, primer and purge for the kiosk machine. Provided here are: a set of color cylinders 44 — such as Light Pink, Classic Red, Nude, Hot Pink, Glitter, Gray, Metallic, White, Lavender, and Navy; a color and prep mechanism 60; a horizontal front back rails 61; a horizontal left-right rails 62; a set of cameras 63 (color, clear coat, purge, etc.); an application nozzles 64; a UV/LED lights and dry/ finish cure chamber 68; a hand rest 69 to separate nails 110; a control/ computer module 71 with power 72; electric power 72; a means 79 to secure pick and place 80, color prep 60, and other accessories to kiosk structure 73; a purge line opening 88 purge reservoir 89; a purge reservoir 89; a hand 100; a prime and purge motor 121; a clean coat motor 122; a color applicator motor 123; and a front to back motor 124.

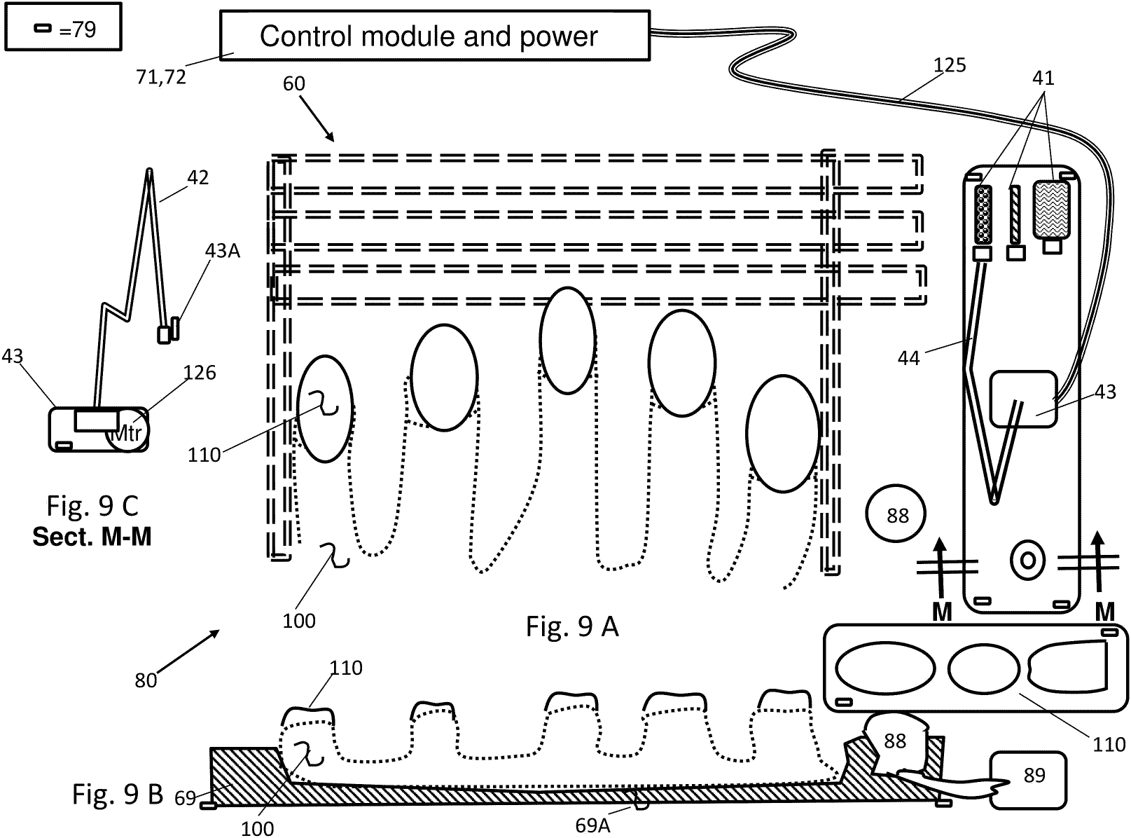

FIGS. 9 A through 9 C are sketches of the nail cleaning, placing and buffing equipment for the kiosk machine. Shown are the following: an augmenting arm 42 of pick and place 43; a pick and place 43 and base; a camera 43A; a set of color cylinders 44 — such as Light Pink, Classic Red, Nude, Hot Pink, Glitter, Gray, Metallic, White, Lavender, and Navy; a color and prep mechanism 60; a UV/LED lights and dry/ finish cure chamber 68; a hand rest 69 to separate nails 110; a structure / plat form 69A for hand rest 69; a control/ computer module 71 with power 72; electric power 72; a means 79 to secure pick and place 80, color prep 60, and other accessories to kiosk structure 73; a pick and place mechanism 80; a purge line opening 88 purge reservoir 89; a purge reservoir 89; a hand 100; a set of artificial nails 110 various types — such as, for example, Coffin, Stiletto, Square, Round, and Almond among others; and an articulation motor 126.

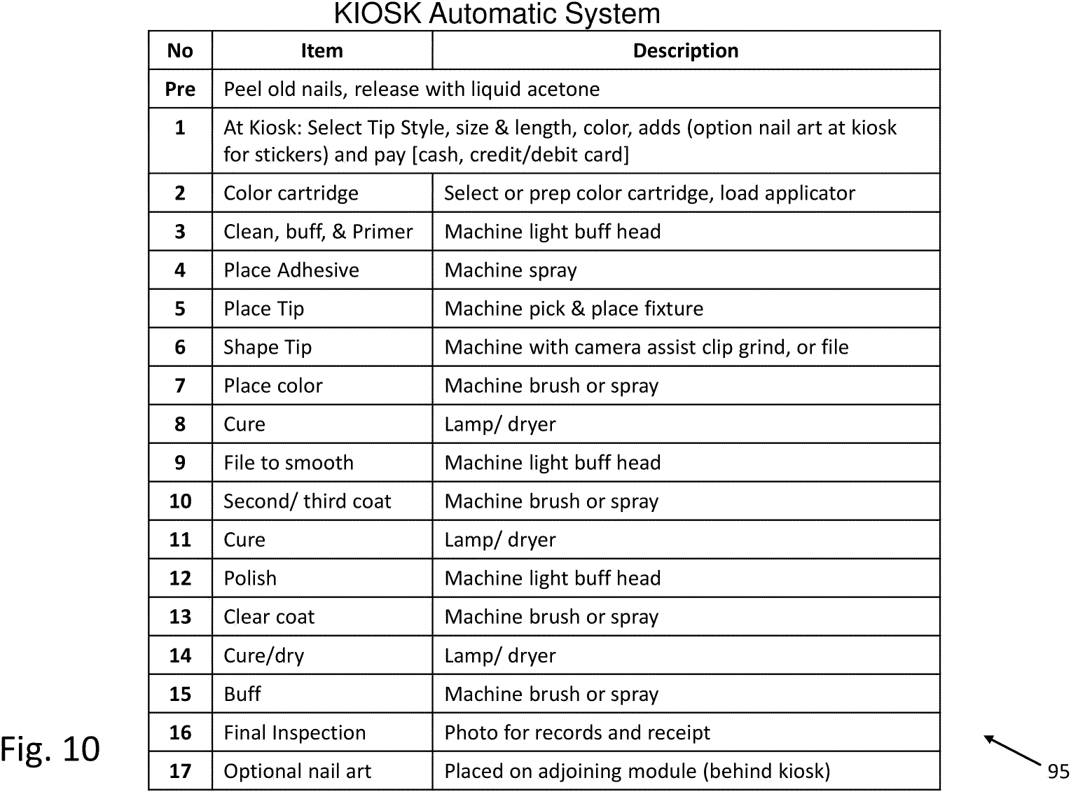

FIG. 10 is a sketch of process steps for a kiosk machine. This is described in the operation section, below.

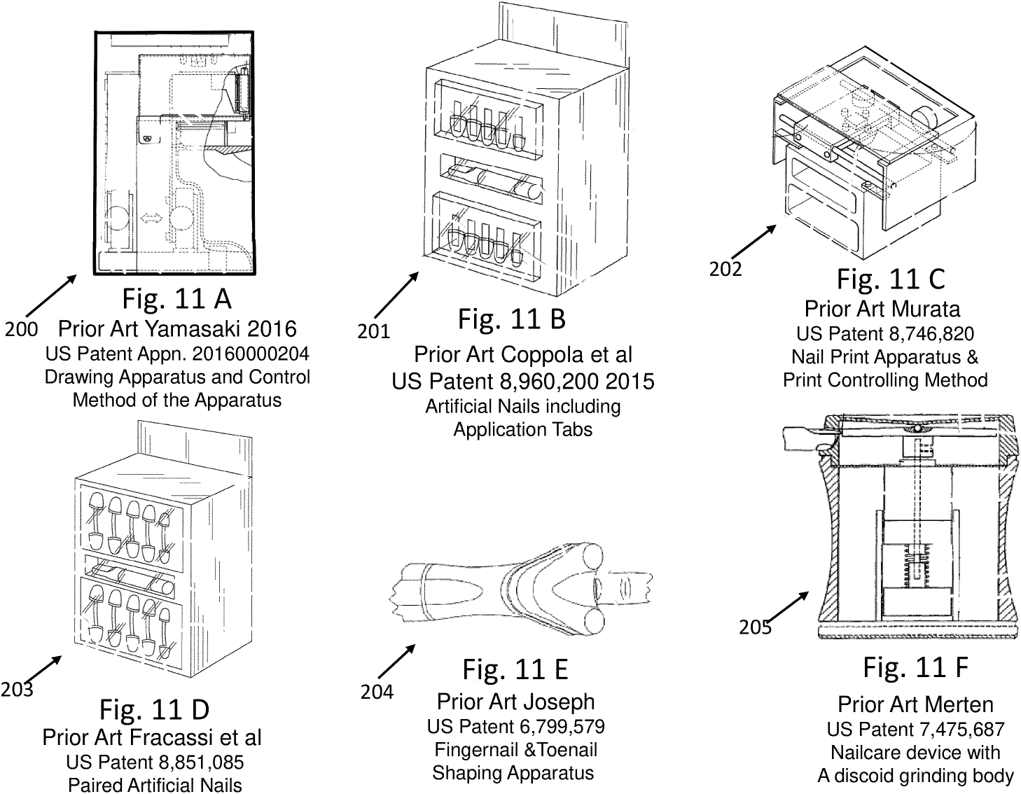

FIGS. 11 A through 11 F are sketches of prior art for nail application machines. Shown in these sketches are: a prior art 200 U.S. Pat. Application 20160000204 — Yamasaki —called a DRAWING APPARATUS AND CONTROL METHOD OF THE DRAWING APPARATUS; a prior Art 201 U.S. Pat. 8960200 — Coppola et al.-called an Artificial nail including application tabs; a prior Art 202 U.S. Pat. 8746820 — Murata— called a Nail print apparatus and print controlling method; a prior Art 203 U.S. Pat. 8851085 — Fracassi, et al.— called Paired artificial nails; a prior Art 204 U.S. Pat. 6799579 — Joseph — called a Fingernail and toenail shaping apparatus; and a prior Art 205 U.S. Pat. 7475687 — Merten — called a Nailcare device with a discoid grinding body driven by an electric.

The anticipated materials for the Commercial nail machine and bench 30, the Single technician bench and machine 33, the Multiple technician commercial bench and machine 35, and the working parts and structure of the Kiosk nail placement machine 70 include: for the part contact surfaces -an Acrylonitrile Butadiene Styrene (ABS), high temperature Delrin RTM plastic, a 304 Stainless Steel, a FDA approved Acetal (Polyoxymethylene, POM)material or equal for moving belts or drive components, a 304 Stainless Steel and a 304 Stainless Steel Tubing with wash features for cleanability for structures and encasing sides and end structures. All are washable with hot water and commercial/ industrial soaps for preparation, and all can resist extreme hot water and steam sprays for quasi sterilization. Sizes and construction details anticipated are wash down tools and shielded electric driven motor/gearbox; and all bearings to be sealed. Other materials include Polyvinyl Chloride (PVC), Polyethylene terephthalate (PETE or PET), and high temperature Polypropylene (PP) compounds. As durable and composite materials are developed, it is anticipated they can replace some of the Stainless-Steel components.

The details mentioned here are exemplary and not limiting. Other specific components and manners specific to describing a Special commercial nail application bench or kiosk machines and related processes can be added as a person having ordinary skill in the field of the art of artificial nail placement, coloring, and finishing devices and their uses well appreciates.

### Operation of the Preferred Embodiment

This invention is a Special commercial nail application bench machine 35, kiosk 70, and process 90,95 comprised of combinations of many components and several steps. They have been described in the above embodiments. The manner of how the device operates is described below. One notes well that the description above and the operation described here must be taken together to fully illustrate the concept of the Special commercial nail application bench machine, kiosk, and process. The preferred embodiments of the Special commercial nail application machine and process are comprised as follows: (1) A Special commercial nail application bench machine for multiple technicians comprised of: (a) a multiple technician commercial bench structure with sides, ends, and a top; (b) a set of hand rests; (c) a pair of UV/LED lights and dry/finish cure chamber; (d) pick and place for artificial nail placement with camera assist; (e) an articulated motorized arm for nail preparation, removal and preparation; (f) a colored polish and clearcoat application mechanism with cartridges with polish, clearcoat and adhesives; and (g) a means to secure the pick and place and other components to the bench structure wherein the Special commercial nail application machine can be used for rapid and repeatable quality artificial nail placement by nail technicians. (2) A Special commercial nail application kiosk machine comprised of: (a) a kiosk structure with a base and an input/ selection screen having control accessories; (b) a set of hand rests; (c) a pair of UV/LED lights and dry/finish cure chamber; (d) pick and place for artificial nail placement with camera assist; (e) an articulated motorized arm for nail preparation, removal and preparation; (f) a colored polish and clearcoat application mechanism with cartridges with polish, clearcoat and adhesives; and (g) a means to secure the pick and place and other components to the kiosk structure wherein the Special commercial nail application machine can be used for rapid and repeatable quality artificial nail placement using a computer controlled kiosk. AND (3) A Special commercial nail application process by a nail technician on a bench comprised of the following steps: Step 1: Select Tip Length, Style, color, adds — Client and stylist discussion; Step 2: Color cartridge — Select or prep color cartridge, load applicator; Step 3: Remove old — Peel, release liquid acetone; Step 4: Clean, buff, & Primer — Manual or light buff head; Step 5: Size nail — Measure natural surface and match to tip; Step 6: Place Adhesive — Manual Application or spray; Step 7: Place Tip - Manual or pick and place fixture; Step 8: Shape Tip — Clip grind, hand or machine file; Step 9: Place color —Brush or dip, gel or acrylic applicator; Step 10: Cure — Lamp/ dryer; Step 11: File to smooth — Manual or light buff head; Step 11A: Thickness check mechanism 50; Step 12: Second/ third coat — Brush or dip, gel or acrylic applicator; Step 12A: Thickness check mechanism 50; Step 13: Cure — Lamp/ dryer; Step 14; Polish — Manual or light buff head; Step 15: Clear coat — Brush, gel or acrylic applicator; Step 16: Cure/dry —Lamp/ dryer; Step 17: Buff — Manual buff; and Step 18: Final Inspection —Inspect quality by stylist.

FIG. 4 is a process flow for the commercial nail technician. These steps include:
Step 1: Select Tip Length, Style, color, adds – by a client and stylist discussion;
Step 2: Color cartridge - Select a cartridge, compare with color selected and prepare and load the color cartridge into applicator;
Step 3: Remove old - Peel, release liquid acetone;
Step 4: Clean, buff, & Primer - Manual or light buff head;
Step 5: Size nail - Measure natural surface and match to tip;
Step 6: Place Adhesive - Manual Application or spray;
Step 7: Place Tip - Manual or pick and place fixture;
Step 8: Shape Tip - Clip grind, hand, or machine file;
Step 9: Place color - Brush or dip, gel, or acrylic applicator;
Step 10: Cure - Lamp/ dryer;
Step 11: File to smooth - Manual or light buff head;
Step 11A: Check thickness and add additional or buff;
Step 12: Second/ third coat - Brush or dip, gel, or acrylic applicator;
Step 12A: Check thickness and add additional or buff;
Step 13: Cure - Lamp/ dryer;
Step 14; Polish - Manual or light buff head;
Step 15: Clear coat - Brush, gel, or acrylic applicator;
Step 16: Cure/dry - Lamp/ dryer;
Step 17: Buff - Manual buff; and
Step 18: Final Inspection - Inspect quality by stylist.

FIG. 5 are drawings of the various steps for the commercial nail application. Shown here are the steps in FIG. 4. In addition, shown are: a commercial nail machine and bench 30; a battery or electric operated Dremel/rotary tool 40; a set of color cylinders 44 - such as Light Pink, Classic Red, Nude, Hot Pink, Glitter, Gray, Metallic, White, Lavender, and Navy; a UV/LED lights and dry/ finish cure chamber 68; and a visual process 99 for commercial nail placement from bench.

FIG. 10 is a sketch of process steps for a kiosk machine.

| No | Item | Description |
|---|---|---|
| Pre | Peel old nails, release with liquid acetone | |
| 1 | At Kiosk: Select Tip Style, size & length, color, adds (option nail art at kiosk for stickers) and pay [cash, credit/debit card] | |
| 2 | Color cartridge | Select or prepare a color cartridge, and load applicator |
| 3 | Clean, buff, & Primer | Machine light buff head |
| 4 | Place Adhesive | Machine spray |
| 5 | Place Tip | Machine pick & place fixture |
| 6 | Shape Tip | Machine with camera assist clip grind, or file |
| 7 | Place color | Machine brush or spray |
| 8 | Cure | Lamp/ dryer |
| 9 | File to smooth | Machine light buff head |
| 10 | Second/ third coat | Machine brush or spray |
| 11 | Cure | Lamp/ dryer |
| 11A | Check Thickness | Thickness check mechanism 50 |
| 12 | Polish | Machine light buff head |
| 12A | Check Thickness | Thickness check mechanism 50 |
| 13 | Clear coat | Machine brush or spray |
| 14 | Cure/dry | Lamp/ dryer |
| 15 | Buff | Machine brush or spray |
| 16 | Final Inspection | Photo for records and receipt |
| 17 | Optional nail art | Placed on adjoining module (behind kiosk) |

With this description it is to be understood that this invention is a special commercial nail application bench machine, kiosk, and process comprised of combinations of many components and several steps. is not to be limited to only the disclosed embodiment of product. The features of the bench, kiosk and process are intended to cover various modifications and equivalent arrangements included within the spirit and scope of the description.

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

Unless defined otherwise, all technical and scientific terms used herein have the same meaning as commonly understood by one of ordinary skill in the art to which these inventions belong. Although any methods and materials similar or equivalent to those described herein can also be used in the practice or testing of the present inventions, the preferred methods and materials are now described above in the foregoing paragraphs.

Other embodiments of the invention are possible. Although the description above contains much specificity, these should not be construed as limiting the scope of the invention, but as merely providing illustrations of some of the presently preferred embodiments of this invention. It is also contemplated that various combinations or subcombinations of the specific features and aspects of the embodiments may be made and still fall within the scope of the inventions. It should be understood that various features and aspects of the disclosed embodiments can be combined with or substituted for one another in order to form varying modes of the disclosed inventions. Thus, it is intended that the scope of at least some of the present inventions herein disclosed should not be limited by the particular disclosed embodiments described above.

The terms recited in the claims should be given their ordinary and customary meaning as determined by reference to relevant entries (e.g., definition of “plane” as a carpenter’s tool would not be relevant to the use of the term “plane” when used to refer to an airplane, etc.) in dictionaries (e.g., widely used general reference dictionaries and/or relevant technical dictionaries), commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used herein in a manner more expansive than its ordinary and customary meaning, the term should be given its ordinary and customary meaning plus the additional expansive meaning, or (b) if a term has been explicitly defined to have a different meaning by reciting the term followed by the phrase “as used herein shall mean” or similar language (e.g., “herein this term means,” “as defined herein,” “for the purposes of this disclosure [the term] shall mean,” etc.). References to specific examples, use of “i.e.,” use of the word “invention,” etc., are not meant to invoke exception (b) or otherwise restrict the scope of the recited claim terms. Other than situations where exception (b) applies, nothing contained herein should be considered a disclaimer or disavowal of claim scope. Accordingly, the subject matter recited in the claims is not coextensive with and should not be interpreted to be coextensive with any particular embodiment, feature, or combination of features shown herein. This is true even if only a single embodiment of the particular feature or combination of features is illustrated and described herein. Thus, the appended claims should be read to be given their broadest interpretation in view of the prior art and the ordinary meaning of the claim terms.

Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques.

The present invention contemplates modifications as would occur to those skilled in the art. While the disclosure has been illustrated and described in detail in the figures and the foregoing description, the same is to be considered as illustrative and not restrictive in character, it being understood that only selected embodiments have been shown and described and that all changes, modifications, and equivalents that come within the spirit of the disclosures described heretofore and or/defined by the following claims are desired to be protected.

What is claimed is:

1. A special commercial nail application bench machine for multiple technicians made of durable and quasi-sterilizable materials and comprised of:
(a) a multiple technician commercial bench structure with a pair of sides, a pair of ends, and a top;
(b) a set of hand rests;
(c) a pair of UV/LED lights and dry/finish cure chamber;
(d) a pick and place for artificial nail placement;
(e) an articulated motorized arm for nail preparation, removal, and preparation;
(f) a colored polish and clearcoat application mechanism with cartridges with polish, clearcoat and adhesives; and
(g) a means to secure the pick and place and other components to the bench structure
wherein the special commercial nail application machine can be used for rapid and repeatable quality artificial nail placement by nail technicians.

2. The special commercial nail application bench machine for multiple technicians of claim 1 wherein the pick and place for artificial nail placement has a camera assist.

3. The special commercial nail application bench machine for multiple technicians made of durable and quasi-sterilizable materials of claim 1 wherein the durable materials are selected from the group consisting of an Acrylonitrile Butadiene Styrene (ABS), a high temperature Delrin RTM plastic, a 304 Stainless Steel, a FDA approved Acetal (Polyoxymethylene, POM) material, a Polyvinyl Chloride (PVC), Polyethylene terephthalate (PETE or PET), a high temperature Polypropylene (PP) compound, and a composite material wherein the durable materials are washable with hot water and commercial/ industrial soaps for preparation and all can resist extreme hot water and steam sprays for quasi sterilization.

4. A Special commercial nail application kiosk machine made of durable and quasi-sterilizable materials and comprised of:
(a) a kiosk structure with a base and an input/ selection screen having control accessories;
(b) a set of hand rests;
(c) a pair of UV/LED lights and dry/finish cure chamber;
(d) pick and place for artificial nail placement with camera assist;
(e) an articulated motorized arm for nail preparation, removal, and preparation;
(f) a colored polish and clearcoat application mechanism with cartridges with polish, clearcoat and adhesives; and
(g) a means to secure the pick and place and other components to the kiosk structure
wherein the Special commercial nail application machine can be used for rapid and repeatable quality artificial nail placement using a computer-controlled kiosk.

5. The Special commercial nail application kiosk machine made of durable and quasi-sterilizable materials of claim 4 wherein the durable materials are selected from the group consisting of an Acrylonitrile Butadiene Styrene (ABS), a high temperature Delrin RTM plastic, a 304 Stainless Steel, a FDA approved Acetal (Polyoxymethylene, POM) material, a Polyvinyl Chloride (PVC), Polyethylene terephthalate (PETE or PET), a high temperature Polypropylene (PP) compound, and a composite material wherein the durable materials are washable with hot water and commercial/ industrial soaps for preparation and all can resist extreme hot water and steam sprays for quasi sterilization.

6. A special commercial nail application process utilized by a nail stylist/ technician on a client’s hands and nails on a bench comprised of the following steps:
Step 1: Select a tip length, a style nail, a color, and any add-on designs - the client and the stylist/ technician discuss the tip length, the style, the color, and any desired add-on designs;
Step 2: Select Color - The client compares a color cartridge with the selected color and the stylist/ technician prepares a color cartridge and load applicator with the selected color cartridge;
Step 3: Remove old nails - The stylist/ technician removes a set of old nails of the client and peels and releases the set of old nails with a liquid acetone;
Step 4: Clean and buff - The stylist/ technician cleans, buffs, and primes the nails of the client manually and/or with a light buff head;
Step 5: Check Tip - The stylist/ technician measures a natural surface of the client’s nails and matches the selected tip length to a tip pf the nails of the client;
Step 6: Place Adhesive - The stylist/ technician places adhesive;
Step 7: Place Tip - the stylist/ technician places tips onto adhesive and nails;
Step 8: Shape Tip - the stylist/ technician clip and file/grinds tip;
Step 9: Place color - the stylist/ technician places the selected color onto the tips;
Step 10: Cure - the stylist/ technician directs the client to place hands, nails, and tips into a lamp and/or dryer to cure the color onto the nails;
Step 11: File to smooth - the stylist/ technician files to smooth the tips;
Step 12: Add a second/ third coat - the stylist/ technician places color onto tips;
Step 13: Cure - The stylist/ technician directs the client to place hands, nails, and tips into a lamp and/or dryer to cure the color onto the nails;
Step 14: Polish - the stylist/ technician polishes the tips;
Step 15: Clear coat - the stylist/ technician places clear coat onto tips;
Step 16: Cure/dry - The stylist/ technician directs the client to place hands, nails, and tips into a lamp and/or dryer to cure the color onto the nails;
Step 17: Final buff - the stylist/ technician final buffs the tips; and
Step 18: Final Inspection - the stylist/ technician inspects the quality of the nail application process.

7. The special commercial nail application process utilized by a nail stylist/ technician on a client’s hands and nails on a bench in claim 6 wherein the Step 6: Place Adhesive is selected from the group consisting of manual placement or spray placement.

8. The special commercial nail application process utilized by a nail stylist/ technician on a client’s hands and nails on a bench in claim 6 wherein the Step 7: Place Tip is selected from the group consisting of manual placement by the nail stylist/ technician and mechanical placement by a pick and place fixture to place nails onto adhesive and nails.

9. The special commercial nail application process utilized by a nail stylist/ technician on a client’s hands and nails on a bench in claim 6 wherein the Step 8: Shape Tip is selected from the group consisting of manual filing or machine filing of the tips.

10. The special commercial nail application process utilized by a nail stylist/ technician on a client’s hands and nails on a bench in claim 6 wherein the Step 9: Place color is selected from the group consisting of using a brush, dipping, placing a gel, and using an acrylic applicator to place the color onto the tips.

11. The special commercial nail application process utilized by a nail stylist/ technician on a client’s hands and nails on a bench in claim 6 wherein the Step 11: File to smooth is selected from the group consisting of the nail stylist/ technician using a manual buffer and using light buff head.

12. The special commercial nail application process utilized by a nail stylist/ technician on a client’s hands and nails on a bench in claim 6 wherein the Step 12: Add a second/ third coat is selected from the group consisting of using a brush, dipping, placing a gel, and using an acrylic applicator to place the second/third color onto the tips.

13. The special commercial nail application process utilized by a nail stylist/ technician on a client’s hands and nails on a bench in claim 6 wherein the Step 14: Polish is selected from the group consisting of the nail stylist/ technician using a manual buffer and using light buff head.

14. The special commercial nail application process utilized by a nail stylist/ technician on a client’s hands and nails on a bench in claim 6 wherein the Step 15: Clear coat is selected from the group consisting of using a brush, dipping, placing a gel, and using an acrylic applicator to place the clear coat onto the tips.

15. The special commercial nail application process utilized by a nail stylist/ technician on a client’s hands and nails on a bench in claim 6 wherein the Step 17: Final buff is selected from the group consisting of the nail stylist/ technician using a manual buffer and using light buff head for a final polis.
